(19) United States
(12) Patent Application Publication
(10) Pub. No.: US 2019/0037568 A1
(43) Pub. Date: Jan. 31, 2019

(54) METHOD, SYSTEM AND APPARATUS

(71) Applicant: NOKIA SOLUTIONS AND NETWORKS OY, Espoo (FI)

(72) Inventors: Yuantao Zhang, Beijing (CN); Yi Zhang, Beijing (CN); De Shan Miao, Beijing (CN); Hong Zhou, Beijing (CN); Klaus Ingemann Pedersen, Aalborg (DK)

(21) Appl. No.: 16/074,421

(22) PCT Filed: Feb. 1, 2016
(86) PCT No.: PCT/CN2016/073050

§ 371 Date: Jul. 31, 2018

(51) Int. Cl. H04W 72/04; H04B 7/06

(52) U.S. Cl. CPC H04W 72/0453; H04B 7/0626

(57) ABSTRACT

There is provided a method comprising providing configuration information to a user device to allow the user device to operate using a first feedback mode for at least one first resource of a set of resources and providing configuration information to the user device to allow the user device to operate using a second feedback mode for the rest of the set of resources, such that the user device is capable of operating using both the first feedback mode and the second feedback mode for the set of resources.

### FIELD

The present application relates to a method, apparatus, system and computer program and in particular but not exclusively to the configuration of transmission mode and feedback mode.

### BACKGROUND

A communication system can be seen as a facility that enables communication sessions between two or more entities such as user terminals, base stations and/or other nodes by providing carriers between the various entities involved in the communications path. A communication system can be provided for example by means of a communication network and one or more compatible communication devices. The communication sessions may comprise, for example, communication of data for carrying communications such as voice, electronic mail (email), text message, multimedia and/or content data and so on. Non-limiting examples of services provided comprise two-way or multi-way calls, data communication or multimedia services and access to a data network system, such as the Internet.

In a wireless communication system at least a part of a communication session between at least two stations occurs over a wireless link. Examples of wireless systems comprise public land mobile networks (PLMN), satellite based communication systems and different wireless local networks, for example wireless local area networks (WLAN). The wireless systems can typically be divided into cells, and are therefore often referred to as cellular systems.

A user can access the communication system by means of an appropriate communication device or terminal. A communication device of a user is often referred to as user equipment (UE). A communication device is provided with an appropriate signal receiving and transmitting apparatus for enabling communications, for example enabling access to a communication network or communications directly with other users. The communication device may access a carrier provided by a station, for example a base station of a cell, and transmit and/or receive communications on the carrier.

The communication system and associated devices typically operate in accordance with a given standard or specification which sets out what the various entities associated with the system are permitted to do and how that should be achieved. Communication protocols and/or parameters which shall be used for the connection are also typically defined. An example of attempts to solve the problems associated with the increased demands for capacity is an architecture that is known as the long-term evolution (LTE) of the Universal Mobile Telecommunications System (UMTS) radio-access technology. LTE is being standardized by the 3rd Generation Partnership Project (3GPP). The various development stages of the 3GPP LTE specifications are referred to as releases. Certain releases of 3GPP LTE (e.g., LTE Rel-11, LTE Rel-12, LTE Rel-13) are targeted towards LTE-Advanced (LTE-A). LTE-A is directed towards extending and optimizing the 3GPP LTE radio access technologies. Another example of a communication system is the 5G concept.

### SUMMARY

In a first aspect there is provided a method comprising providing configuration information to a user device to allow the user device to operate using a first feedback mode for at least one first resource of a set of resources and providing configuration information to the user device to allow the user device to operate using a second feedback mode for the rest of the set of resources, such that the user device is capable of operating using both the first feedback mode and the second feedback mode for the set of resources.

The set of resources may comprise a set of temporal resources.

The set of temporal resources may comprise a time period. The at least one first resource of the set of resources may be at least one first portion of the time period.

The set of resources may comprise a set of frequency resources.

The set of frequency resources may comprise a set of frequency subbands. The at least one first resource of the set of resources may be at least one frequency subband of the set of frequency subbands.

The configuration information may comprise an indication of a first channel state information reference signal periodicity and offset for the at least one first resource of the set of resources and a second channel state information reference signal periodicity and offset for the rest of the set of resources

The configuration information may comprise an indication of a first transmission mode for the at least one first resource of the set of resources and a second transmission mode for the rest of the set of resources.

The first transmission mode and the second transmission mode may comprise a unified transmission mode.

The first transmission mode and the second transmission mode may comprise a close loop transmission mode and an open loop transmission mode, respectively.

The first feedback mode and the second feedback mode may comprise a close loop feedback mode and an open loop feedback mode, respectively.

The configuration information may comprises an indication of the first feedback mode for the at least one first resource of the set of resources and a second feedback mode for the rest of the set of resources

The configuration information may comprise an indication of a first periodicity and offset for channel state information feedback for the at least one first resource of the set of resources and a second periodicity and offset for channel state information feedback for the rest of the set of resources.

In a second aspect there is provided a method comprising receiving configuration information allowing a user device to operate using a first feedback mode for at least one first resource of a set of resources and a second feedback mode for the rest of the set of resources, such that the user device is capable of operating using both the first feedback mode and the second feedback mode for the set of resources.

The set of resources may comprise a set of temporal resources.

The set of temporal resources may comprise a time period. The at least one first resource of the set of resources may be at least one first portion of the time period.

The set of resources may comprise a set of frequency resources.

The set of frequency resources may comprise a set of frequency subbands. The at least one first resource of the set of resources may be at least one frequency subband of the set of frequency subbands.

The configuration information may comprise an indication of a first channel state information reference signal periodicity and offset for the at least one first resource of the set of resources and a second channel state information reference signal periodicity and offset for the rest of the set of resources

The configuration information may comprise an indication of a first transmission mode for the at least one first resource of the set of resources and a second transmission mode for the rest of the set of resources.

The first transmission mode and the second transmission mode may comprise a unified transmission mode.

The first transmission mode and the second transmission mode may comprise a close loop transmission mode and an open loop transmission mode, respectively.

The first feedback mode and the second feedback mode may comprise a close loop feedback mode and an open loop feedback mode, respectively.

The configuration information may comprises an indication of the first feedback mode for the at least one first resource of the set of resources and a second feedback mode for the rest of the set of resources

The configuration information may comprise an indication of a first periodicity and offset for channel state information feedback for the at least one first resource of the set of resources and a second periodicity and offset for channel state information feedback for the rest of the set of resources.

In a third aspect there is provided an apparatus, said apparatus comprising means for providing configuration information to a user device to allow the user device to operate using a first feedback mode for at least one first resource of a set of resources and means for providing configuration information to the user device to allow the user device to operate using a second feedback mode for the rest of the set of resources, such that the user device is capable of operating using both the first feedback mode and the second feedback mode for the set of resources.

The set of resources may comprise a set of temporal resources.

The set of temporal resources may comprise a time period. The at least one first resource of the set of resources may be at least one first portion of the time period.

The set of resources may comprise a set of frequency resources.

The set of frequency resources may comprise a set of frequency subbands. The at least one first resource of the set of resources may be at least one frequency subband of the set of frequency subbands.

The configuration information may comprise an indication of a first channel state information reference signal periodicity and offset for the at least one first resource of the set of resources and a second channel state information reference signal periodicity and offset for the rest of the set of resources

The configuration information may comprise an indication of a first transmission mode for the at least one first resource of the set of resources and a second transmission mode for the rest of the set of resources.

The first transmission mode and the second transmission mode may comprise a unified transmission mode.

The first transmission mode and the second transmission mode may comprise a close loop transmission mode and an open loop transmission mode, respectively.

The first feedback mode and the second feedback mode may comprise a close loop feedback mode and an open loop feedback mode, respectively.

The configuration information may comprises an indication of the first feedback mode for the at least one first resource of the set of resources and a second feedback mode for the rest of the set of resources

The configuration information may comprise an indication of a first periodicity and offset for channel state information feedback for the at least one first resource of the set of resources and a second periodicity and offset for channel state information feedback for the rest of the set of resources.

In a fourth aspect there is provided an apparatus, said apparatus comprising means for receiving configuration information allowing a user device to operate using a first feedback mode for at least one first resource of a set of resources and a second feedback mode for the rest of the set of resources, such that the user device is capable of operating using both the first feedback mode and the second feedback mode for the set of resources.

The set of resources may comprise a set of temporal resources.

The set of temporal resources may comprise a time period. The at least one first resource of the set of resources may be at least one first portion of the time period.

The set of resources may comprise a set of frequency resources.

The set of frequency resources may comprise a set of frequency subbands. The at least one first resource of the set of resources may be at least one frequency subband of the set of frequency subbands.

The configuration information may comprise an indication of a first channel state information reference signal periodicity and offset for the at least one first resource of the set of resources and a second channel state information reference signal periodicity and offset for the rest of the set of resources

The configuration information may comprise an indication of a first transmission mode for the at least one first resource of the set of resources and a second transmission mode for the rest of the set of resources.

The first transmission mode and the second transmission mode may comprise a unified transmission mode.

The first transmission mode and the second transmission mode may comprise a close loop transmission mode and an open loop transmission mode, respectively.

The first feedback mode and the second feedback mode may comprise a close loop feedback mode and an open loop feedback mode, respectively.

The configuration information may comprises an indication of the first feedback mode for the at least one first resource of the set of resources and a second feedback mode for the rest of the set of resources

The configuration information may comprise an indication of a first periodicity and offset for channel state information feedback for the at least one first resource of the set of resources and a second periodicity and offset for channel state information feedback for the rest of the set of resources.

In a fifth aspect there is provided an apparatus comprising at least one processor and at least one memory including a computer program code, the at least one memory and the computer program code configured to, with the at least one processor, cause the apparatus at least to provide configuration information to a user device to allow the user device to operate using a first feedback mode for at least one first resource of a set of resources and provide configuration information to the user device to allow the user device to operate using a second feedback mode for the rest of the set of resources, such that the user device is capable of operating using both the first feedback mode and the second feedback mode for the set of resources.

The set of resources may comprise a set of temporal resources.

The set of temporal resources may comprise a time period. The at least one first resource of the set of resources may be at least one first portion of the time period.

The set of resources may comprise a set of frequency resources.

The set of frequency resources may comprise a set of frequency subbands. The at least one first resource of the set of resources may be at least one frequency subband of the set of frequency subbands.

The configuration information may comprise an indication of a first channel state information reference signal periodicity and offset for the at least one first resource of the set of resources and a second channel state information reference signal periodicity and offset for the rest of the set of resources

The configuration information may comprise an indication of a first transmission mode for the at least one first resource of the set of resources and a second transmission mode for the rest of the set of resources.

The first transmission mode and the second transmission mode may comprise a unified transmission mode.

The first transmission mode and the second transmission mode may comprise a close loop transmission mode and an open loop transmission mode, respectively.

The first feedback mode and the second feedback mode may comprise a close loop feedback mode and an open loop feedback mode, respectively.

The configuration information may comprises an indication of the first feedback mode for the at least one first resource of the set of resources and a second feedback mode for the rest of the set of resources

The configuration information may comprise an indication of a first periodicity and offset for channel state information feedback for the at least one first resource of the set of resources and a second periodicity and offset for channel state information feedback for the rest of the set of resources.

In a sixth aspect there is provided an apparatus comprising at least one processor and at least one memory including a computer program code, the at least one memory and the computer program code configured to, with the at least one processor, cause the apparatus at least to receive configuration information allowing a user device to operate using a first feedback mode for at least one first resource of a set of resources and a second feedback mode for the rest of the set of resources, such that the user device is capable of operating using both the first feedback mode and the second feedback mode for the set of resources.

The set of resources may comprise a set of temporal resources.

The set of temporal resources may comprise a time period. The at least one first resource of the set of resources may be at least one first portion of the time period.

The set of resources may comprise a set of frequency resources.

The set of frequency resources may comprise a set of frequency subbands. The at least one first resource of the set of resources may be at least one frequency subband of the set of frequency subbands.

The configuration information may comprise an indication of a first channel state information reference signal periodicity and offset for the at least one first resource of the set of resources and a second channel state information reference signal periodicity and offset for the rest of the set of resources

The configuration information may comprise an indication of a first transmission mode for the at least one first resource of the set of resources and a second transmission mode for the rest of the set of resources.

The first transmission mode and the second transmission mode may comprise a unified transmission mode.

The first transmission mode and the second transmission mode may comprise a close loop transmission mode and an open loop transmission mode, respectively.

The first feedback mode and the second feedback mode may comprise a close loop feedback mode and an open loop feedback mode, respectively.

The configuration information may comprises an indication of the first feedback mode for the at least one first resource of the set of resources and a second feedback mode for the rest of the set of resources

The configuration information may comprise an indication of a first periodicity and offset for channel state information feedback for the at least one first resource of the set of resources and a second periodicity and offset for channel state information feedback for the rest of the set of resources.

In a seventh aspect there is provided a computer program embodied on a non-transitory computer-readable storage medium, the computer program comprising program code for controlling a process to execute a process, the process comprising providing configuration information to a user device to allow the user device to operate using a first feedback mode for at least one first resource of a set of resources and providing configuration information to the user device to allow the user device to operate using a second feedback mode for the rest of the set of resources, such that the user device is capable of operating using both the first feedback mode and the second feedback mode for the set of resources.

The set of resources may comprise a set of temporal resources.

The set of temporal resources may comprise a time period. The at least one first resource of the set of resources may be at least one first portion of the time period.

The set of resources may comprise a set of frequency resources.

The set of frequency resources may comprise a set of frequency subbands. The at least one first resource of the set of resources may be at least one frequency subband of the set of frequency subbands.

The configuration information may comprise an indication of a first channel state information reference signal periodicity and offset for the at least one first resource of the set of resources and a second channel state information reference signal periodicity and offset for the rest of the set of resources

The configuration information may comprise an indication of a first transmission mode for the at least one first resource of the set of resources and a second transmission mode for the rest of the set of resources.

The first transmission mode and the second transmission mode may comprise a unified transmission mode.

The first transmission mode and the second transmission mode may comprise a close loop transmission mode and an open loop transmission mode, respectively.

The first feedback mode and the second feedback mode may comprise a close loop feedback mode and an open loop feedback mode, respectively.

The configuration information may comprises an indication of the first feedback mode for the at least one first resource of the set of resources and a second feedback mode for the rest of the set of resources

The configuration information may comprise an indication of a first periodicity and offset for channel state information feedback for the at least one first resource of the set of resources and a second periodicity and offset for channel state information feedback for the rest of the set of resources.

In an eighth aspect there is provided a computer program embodied on a non-transitory computer-readable storage medium, the computer program comprising program code for controlling a process to execute a process, the process comprising receiving configuration information allowing a user device to operate using a first feedback mode for at least one first resource of a set of resources and a second feedback mode for the rest of the set of resources, such that the user device is capable of operating using both the first feedback mode and the second feedback mode for the set of resources.

The set of resources may comprise a set of temporal resources.

The set of temporal resources may comprise a time period. The at least one first resource of the set of resources may be at least one first portion of the time period.

The set of resources may comprise a set of frequency resources.

The set of frequency resources may comprise a set of frequency subbands. The at least one first resource of the set of resources may be at least one frequency subband of the set of frequency subbands.

The configuration information may comprise an indication of a first channel state information reference signal periodicity and offset for the at least one first resource of the set of resources and a second channel state information reference signal periodicity and offset for the rest of the set of resources

The configuration information may comprise an indication of a first transmission mode for the at least one first resource of the set of resources and a second transmission mode for the rest of the set of resources.

The first transmission mode and the second transmission mode may comprise a unified transmission mode.

The first transmission mode and the second transmission mode may comprise a close loop transmission mode and an open loop transmission mode, respectively.

The first feedback mode and the second feedback mode may comprise a close loop feedback mode and an open loop feedback mode, respectively.

The configuration information may comprises an indication of the first feedback mode for the at least one first resource of the set of resources and a second feedback mode for the rest of the set of resources

The configuration information may comprise an indication of a first periodicity and offset for channel state information feedback for the at least one first resource of the set of resources and a second periodicity and offset for channel state information feedback for the rest of the set of resources.

In a ninth aspect there is provided a computer program product for a computer, comprising software code portions for performing the steps the method of the first and second aspect when said product is run on the computer.

In the above, many different embodiments have been described. It should be appreciated that further embodiments may be provided by the combination of any two or more of the embodiments described above.

### DESCRIPTION OF FIGURES

Embodiments will now be described, by way of example only, with reference to the accompanying Figures in which:

FIG. 1 shows a schematic diagram of an example communication system comprising a base station and a plurality of communication devices;

FIG. 2 shows a schematic diagram of an example mobile communication device;

FIG. 3 shows the relationship between mobile speed and coherence time;

FIG. 4 shows throughput against signal-to-interference-plus-noise ratio (SINR) for closed loop and open loop transmission;

FIG. 5 shows schematic diagram of downlink (DL) and uplink (UL) subframes and the timing of DL hybrid automatic repeat request (HARQ) and CSI feedback;

FIG. 6 shows a flow diagram of a method according to an embodiment;

FIG. 7 shows a schematic diagram of DL subframe configured with band specific transmission mode and CSI-RS transmission according to an embodiment;

FIG. 8 shows a schematic diagram of DL and UL subframes configured with time period specific transmission mode and CSI feedback according to an embodiment;

FIG. 9 shows a schematic diagram of an example control apparatus;

### DETAILED DESCRIPTION

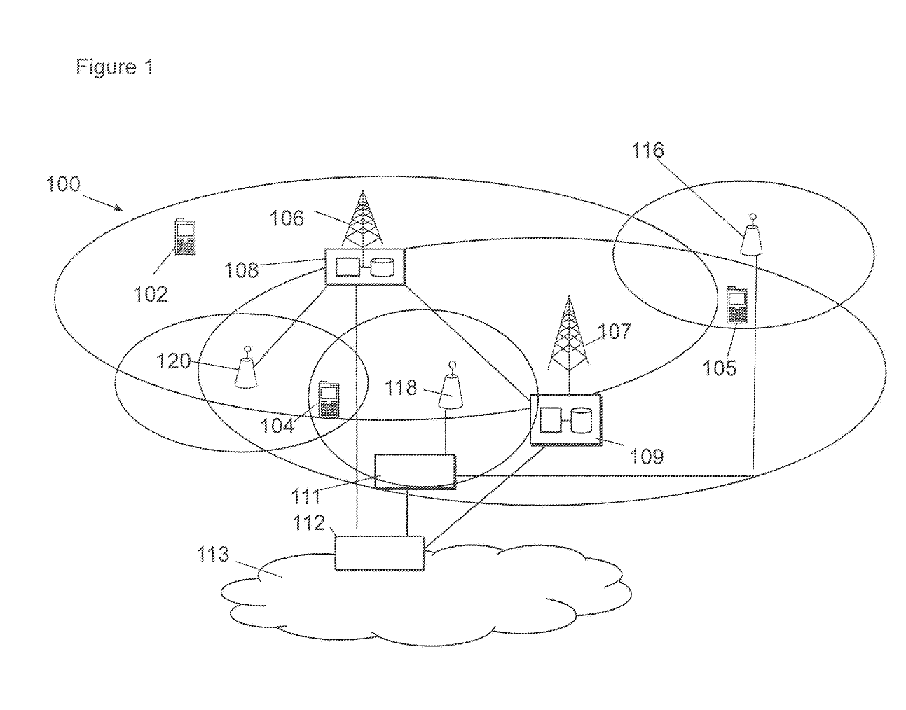

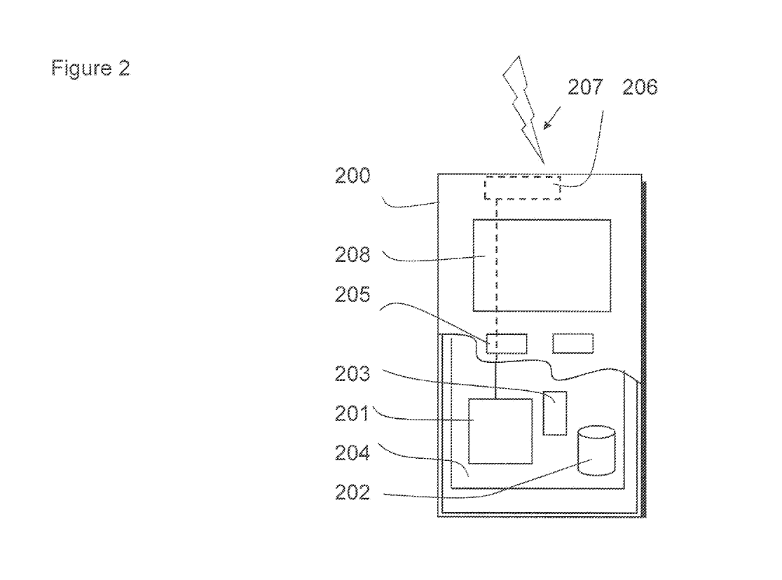

Before explaining in detail the examples, certain general principles of a wireless communication system and mobile communication devices are briefly explained with reference to FIGS. 1 to 2 to assist in understanding the technology underlying the described examples.

In a wireless communication system 100, such as that shown in FIG. 1, mobile communication devices or user equipment (UE) 102, 104, 105 are provided wireless access via at least one base station or similar wireless transmitting and/or receiving node or point. Base stations are typically controlled by at least one appropriate controller apparatus, so as to enable operation thereof and management of mobile communication devices in communication with the base stations. The controller apparatus may be located in a radio access network (e.g. wireless communication system 100) or in a core network (CN) (not shown) and may be implemented as one central apparatus or its functionality may be distributed over several apparatus. The controller apparatus may be part of the base station and/or provided by a separate entity such as a Radio Network Controller. In FIG. 1 control apparatus 108 and 109 are shown to control the respective macro level base stations 106 and 107. The control apparatus of a base station can be interconnected with other control entities. The control apparatus is typically provided with memory capacity and at least one data processor. The control apparatus and functions may be distributed between a plurality of control units. In some systems, the control apparatus may additionally or alternatively be provided in a radio network controller.

LTE systems may however be considered to have a so-called “flat” architecture, without the provision of RNCs; rather the (e)NB is in communication with a system architecture evolution gateway (SAE-GW) and a mobility management entity (MME), which entities may also be pooled meaning that a plurality of these nodes may serve a plurality (set) of (e)NBs. Each UE is served by only one MME and/or S-GW at a time and the (e)NB keeps track of current association. SAE-GW is a “high-level” user plane core network element in LTE, which may consist of the S-GW and the P-GW (serving gateway and packet data network gateway, respectively). The functionalities of the S-GW and P-GW are separated and they are not required to be co-located.

In FIG. 1 base stations 106 and 107 are shown as connected to a wider communications network 113 via gateway 112. A further gateway function may be provided to connect to another network.

The smaller base stations 116, 118 and 120 may also be connected to the network 113, for example by a separate gateway function and/or via the controllers of the macro level stations. The base stations 116, 118 and 120 may be pico or femto level base stations or the like. In the example, stations 116 and 118 are connected via a gateway 111 whilst station 120 connects via the controller apparatus 108. In some embodiments, the smaller stations may not be provided. Smaller base stations 116, 118 and 120 may be part of a second network, for example WLAN and may be WLAN APs.

A possible mobile communication device will now be described in more detail with reference to FIG. 2 showing a schematic, partially sectioned view of a communication device 200. Such a communication device is often referred to as user equipment (UE) or terminal. An appropriate mobile communication device may be provided by any device capable of sending and receiving radio signals. Non-limiting examples comprise a mobile station (MS) or mobile device such as a mobile phone or what is known as a ‘smart phone’, a computer provided with a wireless interface card or other wireless interface facility (e.g., USB dongle), personal data assistant (PDA) or a tablet provided with wireless communication capabilities, or any combinations of these or the like. A mobile communication device may provide, for example, communication of data for carrying communications such as voice, electronic mail (email), text message, multimedia and so on. Users may thus be offered and provided numerous services via their communication devices. Non-limiting examples of these services comprise two-way or multi-way calls, data communication or multimedia services or simply an access to a data communications network system, such as the Internet. Users may also be provided broadcast or multicast data. Non-limiting examples of the content comprise downloads, television and radio programs, videos, advertisements, various alerts and other information.

The mobile device 200 may receive signals over an air or radio interface 207 via appropriate apparatus for receiving and may transmit signals via appropriate apparatus for transmitting radio signals. In FIG. 2 transceiver apparatus is designated schematically by block 206. The transceiver apparatus 206 may be provided for example by means of a radio part and associated antenna arrangement. The antenna arrangement may be arranged internally or externally to the mobile device.

A mobile device is typically provided with at least one data processing entity 201, at least one memory 202 and other possible components 203 for use in software and hardware aided execution of tasks it is designed to perform, including control of access to and communications with access systems and other communication devices. The data processing, storage and other relevant control apparatus can be provided on an appropriate circuit board and/or in chipsets. This feature is denoted by reference 204. The user may control the operation of the mobile device by means of a suitable user interface such as key pad 205, voice commands, touch sensitive screen or pad, combinations thereof or the like. A display 208, a speaker and a microphone can be also provided. Furthermore, a mobile communication device may comprise appropriate connectors (either wired or wireless) to other devices and/or for connecting external accessories, for example hands-free equipment, thereto.

The communication devices 102, 104, 105 may access the communication system based on various access techniques, such as code division multiple access (CDMA), or wideband CDMA (WCDMA). Other non-limiting examples comprise time division multiple access (TDMA), frequency division multiple access (FDMA) and various schemes thereof such as the interleaved frequency division multiple access (IFDMA), single carrier frequency division multiple access (SC-FDMA) and orthogonal frequency division multiple access (OFDMA), space division multiple access (SDMA) and so on. Signalling mechanisms and procedures, which may enable a device to address in-device coexistence (IDC) issues caused by multiple transceivers, may be provided with help from the LTE network. The multiple transceivers may be configured for providing radio access to different radio technologies.

An example of wireless communication systems are architectures standardized by the 3rd Generation Partnership Project (3GPP). A latest 3GPP based development is often referred to as the long term evolution (LTE) of the Universal Mobile Telecommunications System (UMTS) radio-access technology. The various development stages of the 3GPP specifications are referred to as releases. More recent developments of the LTE are often referred to as LTE Advanced (LTE-A). The LTE employs a mobile architecture known as the Evolved Universal Terrestrial Radio Access Network (E-UTRAN). Base stations of such systems are known as evolved or enhanced Node Bs (eNBs) and provide E-UTRAN features such as user plane Packet Data Convergence/Radio Link Control/Medium Access Control/Physical layer protocol (PDCP/RLC/MAC/PHY) and control plane Radio Resource Control (RRC) protocol terminations towards the communication devices. Other examples of radio access system comprise those provided by base stations of systems that are based on technologies such as wireless local area network (WLAN) and/or WiMax (Worldwide Interoperability for Microwave Access). A base station can provide coverage for an entire cell or similar radio service area.

Another example of a suitable communications system is the 5G concept. Network architecture in 5G may be quite similar to that of the LTE-advanced. Changes to the network architecture may depend on the need to support various radio technologies and finer QoS support, and some on-demand requirements for e.g. QoS levels to support QoE of user point of view. Also network aware services and applications, and service and application aware networks may bring changes to the architecture. Those are related to Information Centric Network (ICN) and User-Centric Content Delivery Network (UC-CDN) approaches. 5G may use multiple input-multiple output (MIMO) antennas, many more base stations or nodes than the LTE (a so-called small cell concept), including macro sites operating in co-operation with smaller stations and perhaps also employing a variety of radio technologies for better coverage and enhanced data rates.

It should be appreciated that future networks may utilise network functions virtualization (NFV) which is a network architecture concept that proposes virtualizing network node functions into “building blocks” or entities that may be operationally connected or linked together to provide services. A virtualized network function (VNF) may comprise one or more virtual machines running computer program codes using standard or general type servers instead of customized hardware. Cloud computing or data storage may also be utilized. In radio communications this may mean node operations to be carried out, at least partly, in a server, host or node operationally coupled to a remote radio head. It is also possible that node operations will be distributed among a plurality of servers, nodes or hosts. It should also be understood that the distribution of labour between core network operations

Multiple input multiple output (MIMO) technology has been considered to meet the demand of higher data rate and better coverage in modern wireless communication systems. Table 1 shows various DL transmission modes defined in LTE. Example MIMO transmission schemes include transmit diversity, open loop spatial multiplexing, closed loop spatial multiplexing up to 8 layers with single cell or multiple cell transmission, and with single user (SU-MIMO) or multi-user (MU-MIMO) transmission. Each transmission scheme is introduced by defining a corresponding downlink transmission mode (TM), which corresponds to a specific downlink control information (DCI) format size, specific reference symbols for channel state information (CSI) measurement and demodulation, and specific feedback modes.

TABLE 1

| DL transmission | |
|---|---|
| mode | Transmission scheme |
| Mode 1 | Single antenna port |
| Mode 2 | Transmit diversity |
| Mode 3 | Open-loop spatial multiplexing |
| Mode 4 | Closed-loop spatial multiplexing |
| Mode 5 | Multi-user MIMO |
| Mode 6 | Closed-loop rank = 1 precoding |
| Mode 7 | Beamforming, Single antenna port 5 |
| Mode 8 | Dual layer beamforming |
| Mode 9 | Up to 8 layer closed-loop spatial multiplexing |
| Mode 10 | up to 8 layer closed-loop spatial multiplexing for up |
| | to 3 TPs |

Downlink transmission mode (TM) 3 is defined for an open loop transmission scheme. A UE may be configured with TM3 when the UE operates at a relatively medium to high speed. In such cases the feedback channel state information (CSI) from UE to eNB may be outdated, because the feedback delay (4 ms in LTE between the subframe with measured reference symbol and the subframe with CSI feedback) is larger than the coherence time. The feedback delay may often be larger than the coherence time at medium and high speed.

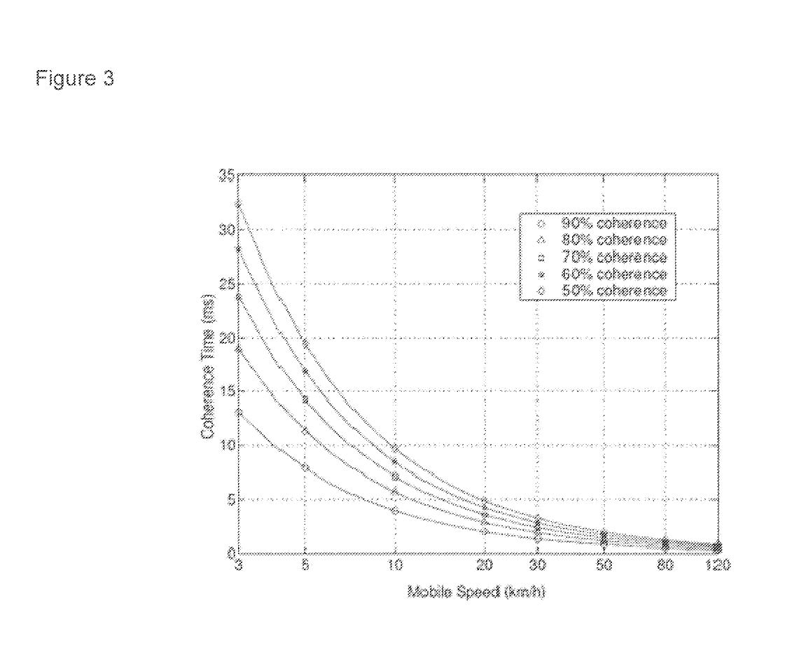

The LTE open loop transmission scheme relies on (common reference signal) CRS to perform channel estimation for both CSI measurement and data demodulation. CRS is transmitted per subframe. According to LTE specification, if eNB sends a CRS/channel state information reference signal (CSI-RS) in subframe n, the measured CSI based on this CRS/CSI-RS is received at least after 4 ms. That is also to say, the processing time of CSI measurement and feedback is assumed to be around 4 ms. Due to this defined timing, for a UE that camps on a certain carrier frequency, if the coherence time is larger than 4 ms (which is common for medium to high speed UEs), the UE would be configured with open loop transmission scheme, even if the reference symbols can be transmitted per subframe. As described with respect to FIG. 3, for a cell with 2 GHz carrier frequency, an eNB typically configures a UE to operate in open loop transmission mode if the UE speed is larger than 20 km/h.

FIG. 3 shows the relationship between coherence time and UE, or mobile, speed. In 2.0 GHz carrier frequency 50% coherence may be used to calculate the coherence time. In FIG. 3, it can be seen that coherence time at 30 km/h is around 4 ms, which is almost equal to the feedback delay. In practice there may also be a delay for eNB processing of the received CSI. Therefore, the time between the sub frame with physical downlink sharing channel (PDSCH) transmission and the subframe with the measured reference symbol is larger than 4 ms. As a result, a UE may be configured with open loop transmission when UE speed is larger than e.g., 20 km/h.

Since the measured channel is outdated when feedback is received, LTE does not support precoding matrix feedback for open loop transmission. Large delay cyclic delay diversity (CDD) may be used for precoding for open loop transmission, which in general is a random precoding scheme.

To reduce the reference symbol overhead and the power consumption in potential 5G systems, per-subframe CRS (as in LTE) may not be transmitted. Thus for open loop transmission, it is most reasonable that the reference symbols for CSI measurement and demodulation will be changed from CRS to CSI-RS (for CSI measurement) and demodulation reference signal (DM-RS) (for demodulation), which is the same (or similar) to the reference symbols used for closed loop transmission.

In LTE closed loop MIMO precoding systems, for each transmission antenna configuration, a set of precoding matrices are constructed. This set of matrices are known as a MIMO codebook. Normally a UE would observe the channel status by measuring cell common reference symbol (CRS) or channel state information reference symbol (CSI-RS) depending on which closed loop TM is configured, select the best precoding matrix according to a specific criterion (e.g., maximum throughput), and feedback the precoding matrix index (PMI) to the eNB. eNB can use this precoding matrix for data packet precoding.

As a comparison, when the CSI feedback delay is shorter than the channel coherence time, the performance of closed loop transmission clearly outperforms open loop transmission.

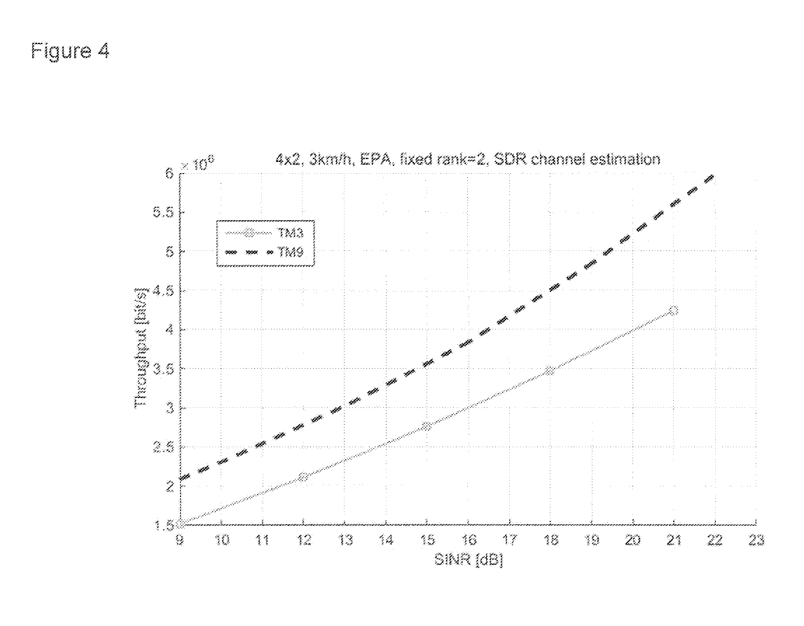

FIG. 4 illustrates the throughput comparison between open loop and closed loop transmission schemes. It is observed the closed loop provides at least larger than 2 dB performance gain over open loop transmission.

In LTE, a UE is semi-statically configured with single transmission mode and single feedback mode. The configuration of close loop transmission mode or open loop transmission mode is determined according to the value of coherence time. UEs configured with open loop transmission scheme cannot obtain closed loop precoding gain.

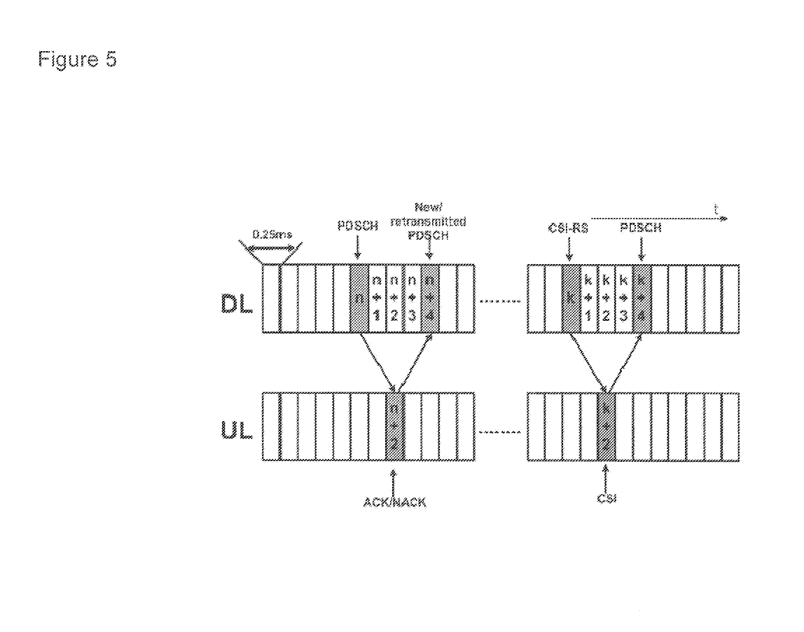

5G may support a shorter transmission time interval (TTI) length than LTE. One reason, among others, may be to support 1 ms RTT to meet the 1 ms end to end latency requirement. This requirement may be fulfilled by having stronger UE/eNB processing capability for channel decoding and acknowledgement/negative acknowledgement (ACK/NACK) feedback. FIG. 5 illustrates one example, where TTI size is 0.25 ms. For PDSCH transmitted in subframe n, the ACK/NACK is feedback at subframe n+2, and the new or retransmitted PDSCH can happen in subframe n+4.

Correspondingly, the processing time for channel measurement and feedback are also reduced to be less than 1 ms. In FIG. 5, for CSI-RS transmitted in subframe k, the CSI is feedback in subframe k+2, and based on that, eNB can used new link adaptation parameters (based on the CSI feedback in subframe k+2) for PDSCH transmitted in subframe k+4.

In a 5G system, the processing time for channel measurement and feedback in UE will be less than 1 ms (as illustrated in FIG. 5). As a result, it may be possible to configure certain medium to high speed UEs to be closed loop transmission scheme, since the feedback delay is less than the coherence time for these UEs (e.g., it is possible for UEs with speed <80 km/h under 2 GHz carrier to be configured with closed loop transmission mode, according to FIG. 3).

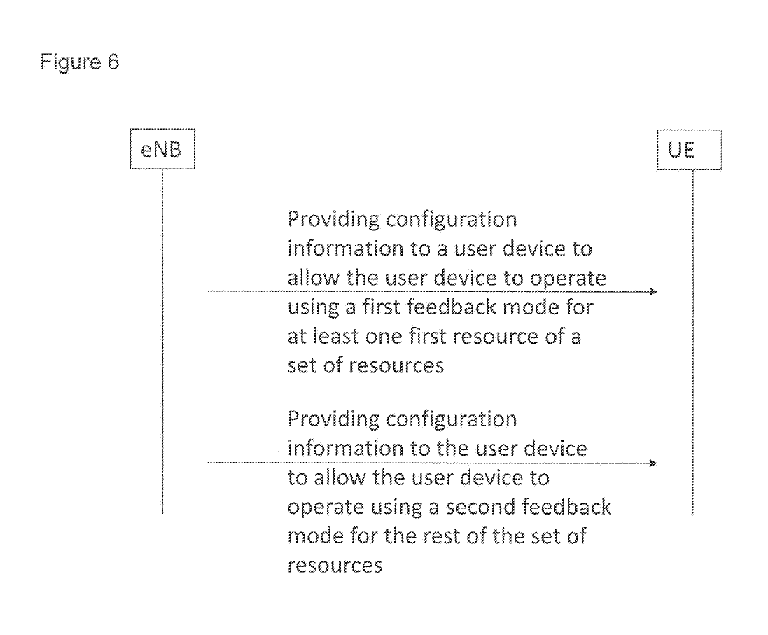

FIG. 6 shows a flowchart of an example method according to embodiments. The method comprises providing configuration information to a user device to allow the user device to operate using a first feedback mode for at least one first resource of a set of resources and providing configuration information to the user device to allow the user device to operate using a second feedback mode for the rest of the set of resources, such that the user device is capable of operating using both the first feedback mode and the second feedback mode for the set of resources.

A method such as that described with reference to FIG. 6 may be performed by an access point e.g., an eNB. The user device, or UE, may be a medium to high speed UE, e.g. a user device having a speed of up to 80 km/h.

The first feedback mode may be a closed loop feedback mode, such as a CSI feedback mode. The second feedback mode may be an open loop feedback mode, such as another CSI feedback mode. The closed loop feedback mode may use channel quality information (CQI) and explicit quantised channel state information as feedback, rather than PMI and RI feedback as assumed for LTE closed loop MIMO schemes

The method may allow, with the boosted UE capability of faster CSI measurement and feedback (<1 ms delay) in 5G, medium to high speed UEs to harvest the closed loop precoding gain without increasing CSI-RS overhead.

The set of resources may comprise temporal resources, such as a time period, and the at least one first resource may comprise at least one first portion of the time period.

Alternatively, or in addition, the set of resources may comprise a set of frequency resources, such as a set of frequency subbands. The at least one first resource may comprise at least one frequency subband. The at least one first resource may comprise at least one frequency subband of the set of subbands.

If the set of resources comprises a set of frequency resources, i.e. the configured feedback mode is subband specific, a user device may be configured as follows, where the at least one first resource comprises at least one configured subband.

The configuration information may comprise an indication of the first feedback mode for the configured subbands and the second feedback mode for other subbands.

The method may comprise configuring a first transmission mode for the configured subbands and another transmission mode for other subbands. That is, the configuration information may comprise an indication of a first transmission mode for the at least one first resource of the set of resources and a second transmission mode for the rest of the set of resources. The first transmission mode may be a closed loop transmission mode. The second transmission mode may be a closed loop transmission mode. As an alternative, there may be a unified transmission mode for both open loop and closed loop transmission, the UE may be configured with the unified transmission mode for all subbands. In this case UE is configured with different feedback mode for the configured set of subbands than the feedback mode for other subbands.

The configuration information may comprise an indication of a first periodicity and offset of CSI-RS transmission for the configured subbands and a second periodicity and offset of CSI-RS transmission for the other subbands to allow configuring a first periodicity and offset of CSI-RS transmission for the configured subbands and a second periodicity and offset of CSI-RS transmission for the other subbands

The configuration information may comprise an indication of a first periodicity and offset for CSI feedback for the configured subbands and a second periodicity and offset for CSI feedback for other subbands to allow configuring a first periodicity and offset for CSI feedback for the configured subbands and a second periodicity and offset for CSI feedback for other subbands.

In practice, the number of configured subbands can be determined by the traffic load from medium to high speed UEs.

In one embodiment, a medium to high speed user device may be provided with configuration information such that it is configured with one transmission mode and feedback mode (e.g., closed loop transmission mode and feedback mode) for certain bands or for a configured set of subbands (out of whole system bandwidth), and be configured with another transmission mode and feedback mode (e.g., open loop transmission mode and feedback mode) for other bands or for the rest of the subbands.

Correspondingly, the periodicity of CSI-RS transmitted in the configured set of subbands is lower than the coherence time so that UE can measure and feedback CSI that can always reflect the accurate channel status and not the outdate information. The periodicity of CSI-RS for other subbands may be much lower than that in the configured subbands, in order to balance the CSI-RS overhead.

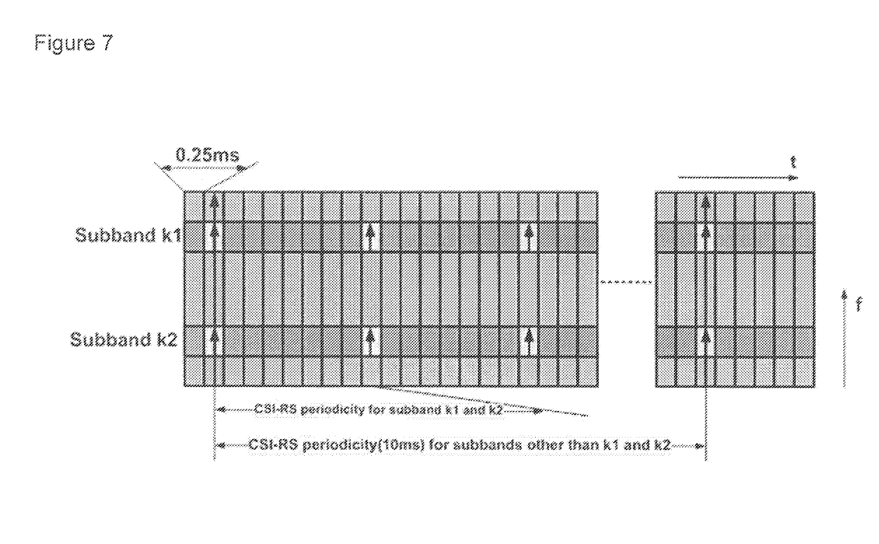

An example embodiment will be described with reference to FIG. 7. UE is configured with closed loop transmission mode and feedback mode for the configured subband k1 and k2, and open loop for the rest of the subbands. The CSI-RS transmission periodicity in subband k1 and k2 is configured to be 8 subframe (i.e., 2 ms) and is configured to be 40 subframes (i.e., 10 ms) for the rest of the subbands. The 2 ms periodicity should be less than coherence time to provide accurate CSI feedback information for these subbands. UE feedback closed loop CSI is provided for the configured subband k1 and k2 while feedback open loop CSI is provided for the rest of the subbands. eNB would schedule closed loop transmission for this UE in the configured subbands with higher priority than scheduling in other subbands, so that UE can obtain the closed loop precoding gain.

Even maintaining the same CSI-RS transmission periodicity (for all subbands) as that in LTE, i.e., >=5 ms, the medium to high speed UEs may enjoy the closed loop precoding gain through the proposed time division transmission modes. This again benefits from the faster CSI measurement and feedback capability in 5G.

If the set of resources comprises temporal resources, i.e. for time period (or time division) based transmission mode and feedback mode, a user device may be configured by an access point as follows, where the configured time period is at least one first portion of a time period.

The configuration information may comprise an indication of the first feedback mode for the configured time period and the second feedback mode for the rest of the time period.

The method may comprise configuring a first transmission mode for the configured time period and another transmission mode for the rest of the time period. That is, the configuration information may comprise an indication of a first transmission mode for the at least one first resource of the set of resources and a second transmission mode for the rest of the set of resources. The first transmission mode may be a closed loop transmission mode. The second transmission mode may be a closed loop transmission mode. As an alternative, there may be a unified transmission mode for both open loop and closed loop transmission, the UE may be configured with the unified transmission mode for all subbands. In this case UE is configured with different feedback mode for the configured set of subbands than the feedback mode for other subbands.

The configuration information may comprise an indication of first periodicity and offset for CSI feedback for the configured time period and a second periodicity and offset for CSI feedback for the rest of the time period to allow configuring a first periodicity and offset for CSI feedback for the configured subbands and a second periodicity and offset for CSI feedback for other subbands.

eNB may set higher priority for scheduling medium to high speed UEs in the configured time period.

The time division transmission modes means that UE can be configured with one transmission mode and feedback mode (e.g., closed loop transmission mode and feedback mode) in a configured time period, and another transmission mode and feedback mode (e.g., open loop transmission mode) in the rest of the time period. The length of the configured time period is less than the coherence time so that the CSI feedback from UE is accurate and closed loop precoding gain can be harvested. The starting subframe of the configured period can take the CSI-RS subframe as the reference.

In practice, the two proposals can be used jointly, for example, using time period specific transmission mode and feedback mode for other subbands.

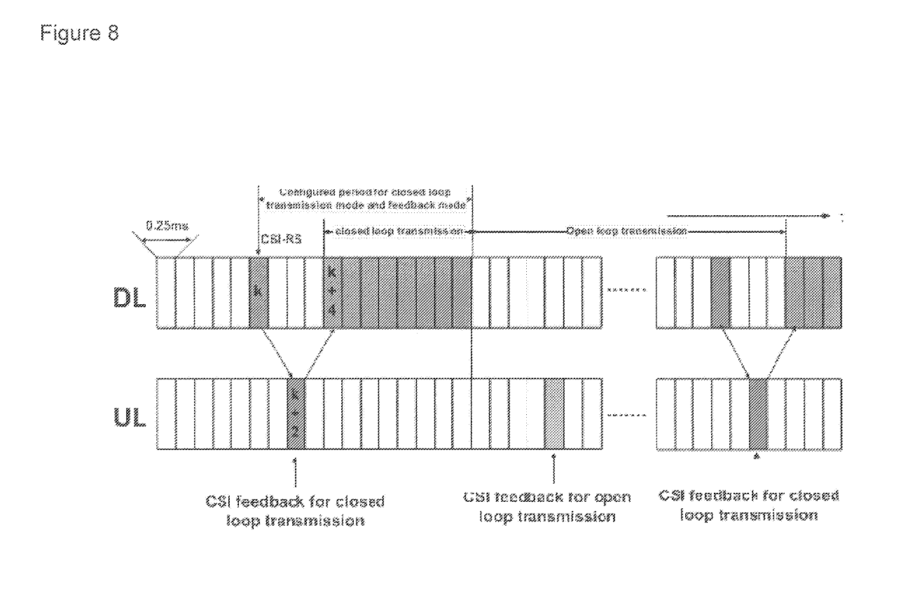

One example embodiment will be described with reference to FIG. 8. The configured time period for closed loop transmission mode and feedback begins right after the subframe n with CSI-RS. UE feedback CSI for closed loop transmission after 2 subframes of CSI-RS subframe (i.e., in k+2), then from subframe k+4, close loop transmission scheme based on the CSI feedback from k+2 can be used for the data transmission. Here it is assumed that the channel coherence time is larger than or equal to 3 ms. eNB would schedule closed loop transmission for this UE in the configured time period with higher priority than scheduling in other period, so that UE can obtain the closed loop precoding gain.

The proposed subband specific and time period specific transmission mode and feedback mode may allow medium to high speed UEs to enjoy the closed loop precoding gain without significantly increased CSI-RS overhead. This may translate to higher spectral efficiency for medium to high speed UEs and/or higher system capacity.

UE follows the eNB configuration for the CSI measurement and feedback, and the DCI detection in the configured time period and/or in the configured subbands, and in other time period and/or in other subbands.

It should be understood that each block of the flowcharts of the Figures and any combination thereof may be implemented by various means or their combinations, such as hardware, software, firmware, one or more processors and/or circuitry.

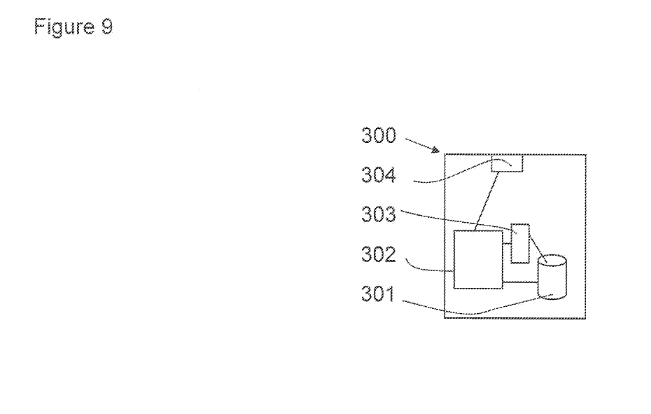

The method may be implemented in entities on a mobile device as described with respect to FIG. 2 or control apparatus as shown in FIG. 9. The method may be implanted in a single processor 201 or control apparatus or across more than one processor or control apparatus. FIG. 9 shows an example of a control apparatus for a communication system, for example to be coupled to and/or for controlling a station of an access system, such as a RAN node, e.g. a base station, (e) node B or 5G AP, a central unit of a cloud architecture or a node of a core network such as an MME or S-GW, a scheduling entity, or a server or host. The control apparatus may be integrated with or external to a node or module of a core network or RAN. In some embodiments, base stations comprise a separate control apparatus unit or module. In other embodiments, the control apparatus can be another network element such as a radio network controller or a spectrum controller. In some embodiments, each base station may have such a control apparatus as well as a control apparatus being provided in a radio network controller. The control apparatus 300 can be arranged to provide control on communications in the service area of the system. The control apparatus 300 comprises at least one memory 301, at least one data processing unit 302, 303 and an input/output interface 304. Via the interface the control apparatus can be coupled to a receiver and a transmitter of the base station. The receiver and/or the transmitter may be implemented as a radio front end or a remote radio head. For example the control apparatus 300 or processor 201 can be configured to execute an appropriate software code to provide the control functions. Control functions may comprise providing configuration information to a user device to allow the user device to operate using a first feedback mode for at least one first resource of a set of resources and providing configuration information to the user device to allow the user device to operate using a second feedback mode for the rest of the set of resources, such that the user device is capable of operating using both the first feedback mode and the second feedback mode for the set of resources.

Alternatively, or in addition, control functions may comprise receiving configuration information allowing a user device to operate using a first feedback mode for at least one first resource of a set of resources and a second feedback mode for the rest of the set of resources, such that the user device is capable of operating using both the first feedback mode and the second feedback mode for the set of resources.

It should be understood that the apparatuses may comprise or be coupled to other units or modules etc., such as radio parts or radio heads, used in or for transmission and/or reception. Although the apparatuses have been described as one entity, different modules and memory may be implemented in one or more physical or logical entities.

It is noted that whilst embodiments have been described in relation to 5G, similar principles maybe applied in relation to other networks and communication systems, having a TTI length and/or processing ability to enable feedback delay which is less than coherence time. Therefore, although certain embodiments were described above by way of example with reference to certain example architectures for wireless networks, technologies and standards, embodiments may be applied to any other suitable forms of communication systems than those illustrated and described herein.

It is also noted herein that while the above describes example embodiments, there are several variations and modifications which may be made to the disclosed solution without departing from the scope of the present invention.

In general, the various embodiments may be implemented in hardware or special purpose circuits, software, logic or any combination thereof. Some aspects of the invention may be implemented in hardware, while other aspects may be implemented in firmware or software which may be executed by a controller, microprocessor or other computing device, although the invention is not limited thereto. While various aspects of the invention may be illustrated and described as block diagrams, flow charts, or using some other pictorial representation, it is well understood that these blocks, apparatus, systems, techniques or methods described herein may be implemented in, as non-limiting examples, hardware, software, firmware, special purpose circuits or logic, general purpose hardware or controller or other computing devices, or some combination thereof.

The embodiments of this invention may be implemented by computer software executable by a data processor of the mobile device, such as in the processor entity, or by hardware, or by a combination of software and hardware. Computer software or program, also called program product, including software routines, applets and/or macros, may be stored in any apparatus-readable data storage medium and they comprise program instructions to perform particular tasks. A computer program product may comprise one or more computer-executable components which, when the program is run, are configured to carry out embodiments. The one or more computer-executable components may be at least one software code or portions of it.

Further in this regard it should be noted that any blocks of the logic flow as in the Figures may represent program steps, or interconnected logic circuits, blocks and functions, or a combination of program steps and logic circuits, blocks and functions. The software may be stored on such physical media as memory chips, or memory blocks implemented within the processor, magnetic media such as hard disk or floppy disks, and optical media such as for example DVD and the data variants thereof, CD. The physical media is a non-transitory media.

The memory may be of any type suitable to the local technical environment and may be implemented using any suitable data storage technology, such as semiconductor based memory devices, magnetic memory devices and systems, optical memory devices and systems, fixed memory and removable memory. The data processors may be of any type suitable to the local technical environment, and may comprise one or more of general purpose computers, special purpose computers, microprocessors, digital signal processors (DSPs), application specific integrated circuits (ASIC), FPGA, gate level circuits and processors based on multi core processor architecture, as non-limiting examples.

Embodiments of the inventions may be practiced in various components such as integrated circuit modules. The design of integrated circuits is by and large a highly automated process. Complex and powerful software tools are available for converting a logic level design into a semiconductor circuit design ready to be etched and formed on a semiconductor substrate.

The foregoing description has provided by way of non-limiting examples a full and informative description of the exemplary embodiment of this invention. However, various modifications and adaptations may become apparent to those skilled in the relevant arts in view of the foregoing description, when read in conjunction with the accompanying drawings and the appended claims. However, all such and similar modifications of the teachings of this invention will still fall within the scope of this invention as defined in the appended claims. Indeed there is a further embodiment comprising a combination of one or more embodiments with any of the other embodiments previously discussed.

1. A method comprising:
providing configuration information to a user device to allow the user device to operate using a first feedback mode for at least one first resource of a set of resources; and
providing configuration information to the user device to allow the user device to operate using a second feedback mode for the rest of the set of resources, such that the user device is capable of operating using both the first feedback mode and the second feedback mode for the set of resources.

2. A method according to claim 1, wherein the set of resources comprises a set of temporal resources.

3. A method according to claim 2, wherein the set of temporal resources comprises a time period and the at least one first resource of the set of resources is at least one first portion of the time period.

4. A method according to claim 1, wherein the set of resources comprises a set of frequency resources.

5. A method according to claim 4, wherein the set of frequency resources is a set of frequency subbands and the at least one first resource of the set of resources is at least one frequency subband of the set of frequency subbands.

6. A method according to claim 4, wherein the configuration information comprises an indication of a first channel state information reference signal periodicity and offset for the at least one first resource of the set of resources and a second channel state information reference signal periodicity and offset for the rest of the set of resources.

7. A method according to claim 1, wherein the configuration information comprises an indication of a first transmission mode for the at least one first resource of the set of resources and a second transmission mode for the rest of the set of resources.

8. A method according to claim 7, wherein the first transmission mode and the second transmission mode comprises a unified transmission mode.

9. A method according to claim 7, wherein the first transmission mode and the second transmission mode comprise a closed loop transmission mode and an open loop transmission mode, respectively.

10. A method according to claim 1 wherein the first feedback mode and the second feedback mode comprise a closed loop feedback mode and an open loop feedback mode, respectively.

11. A method according to claim 1, wherein the configuration information comprises an indication of the first feedback mode for the at least one first resource of the set of resources and a second feedback mode for the rest of the set of resources.

12. A method according to claim 1, wherein the configuration information comprises an indication of a first periodicity and offset for channel state information feedback for the at least one first resource of the set of resources and a second periodicity and offset for channel state information feedback for the rest of the set of resources.

13. A method comprising:
receiving configuration information allowing a user device to operate using a first feedback mode for at least one first resource of a set of resources and a second feedback mode for the rest of the set of resources, such that the user device is capable of operating using both the first feedback mode and the second feedback mode for the set of resources.

14. A method according to claim 13, wherein the set of resources comprises a set of temporal resources.

15. A method according to claim 13, wherein the set of resources comprises a set of frequency resources.

16. A method according to claim 13, wherein the first feedback mode and the second feedback mode comprise a close loop feedback mode and an open loop feedback mode, respectively.

17. (canceled)

18. A computer program product, the computer program product being tangibly embodied on a non-transitory computer-readable storage medium and including instructions that, when executed by at least one processor, are configured to perform the method of claim 1.

19. An apparatus comprising:
at least one processor and at least one memory including a computer program code, the at least one memory and the computer program code configured to, with the at least one processor, cause the apparatus at least to:
provide configuration information to a user device to allow the user device to operate using a first feedback mode for at least one first resource of a set of resources; and
provide configuration information to the user device to allow the user device to operate using a second feedback mode for the rest of the set of resources, such that the user device is capable of operating using both the first feedback mode and the second feedback mode for the set of resources.

20. An apparatus comprising:
at least one processor and at least one memory including a computer program code, the at least one memory and the computer program code configured to, with the at least one processor, cause the apparatus at least to:
receive configuration information allowing a user device to operate using a first feedback mode for at least one first resource of a set of resources and a second feedback mode for the rest of the set of resources, such that the user device is capable of operating using both the first feedback mode and the second feedback mode for the set of resources.
